(19) United States
(12) Patent Application Publication
(10) Pub. No.: US 2007/0295864 A1
(43) Pub. Date: Dec. 27, 2007

(54) Heili-kite, having an cambered streamedline airfoil inflated keel, filled with air or lighter than air substance, with a streamlined airfoil inflated keel, wing, nose, and tail uni-body, pleated stealth like shaped wings, with a bats wing shaped trailing edge and a curved downward cambered airfoil tail design

(76) Inventor: Michael E. Garvin, Grosse Tete, LA (US)

Correspondence Address: Michael E. Garvin, 22650 Hwy 77, Grosse Tete, LA, 70740, US

(21) Appl. No.: 11/475,408

(22) Filed: Jun. 27, 2006

(51) Int. Cl. B64C 31/06

(52) U.S. Cl. 244/153 R

(57) ABSTRACT

The heili-kite is an inflatable-kite having an inflated keel, it also has a uni-body structure consisting of the inflated keel, inflated reinforced pleated wing, inflated nose, and the inflated curved downward tail. The heili-kite is fabricated of a mylar material that is layered over each other in layers or a single layer being over laped multypul times and sealed together to form an air tight pocket with pleats that form the skelatal structure, which when inflated with air, helium, or a lighter than air substance, forms an arodynamic (airfoil) streamlined, stealth like (triangular) shaped kite, that does not need wind to rise in an upward direction to get the sensation of flying a kite, is easy to opperate with one hand control line and can be opperated outdoors and/or indoors for children, teen, and adults alike, and for small children and/or ederly people that have limited knolewge of kite flying, limited mobility, or may be comfined indoors. The heili-kite is a used for sports, pleasure, recreation, work or warning zone, or a signal for help.

### CITED REFERENCES

U.S Pat. DOCUMENTS

| | | | |
|---|---|---|---|
| 6,016,998 | January 2000 | Allsopp | 244/153 R |
| 6,499,695 | December 2002 | Talamo | 244/153 R |
| 4,919,365 | March 1990 | Mews | 244/153 R |
| 5,762,293 | June 1998 | Crosbie | 244/33 |
| 3,957,228 | May 1976 | Kennedy Jr | 244/33 |
| 4,026,504 | May 1977 | Christoffel Jr | 244/155 A |
| 4,216,929 | August 1980 | Holland Jr | 244/153 R |
| 4,846,424 | July 1989 | Prouty | 244/153 R |

### FIELD OF THE INVENTION

This invention relates to a new type of kite flying entertainment or 2 ply kites filled with air helium or lighter than air substance and more particularly, this invention relates to a 2 ply Mylar helium filled kite, having a cambered streamlined airfoil inflated keel with a streamlined airfoil uni-body, reinforced pleated wings from the inside with stealth like shaped uni-body wing that has a trailing edge shaped like that of a bat's (rodent) wing, and cambered curved tail design. The airfoil top or upper surface of uni-body which is cambered for extra lift combined with the inflated keel provides a wider angle of attack 15 degrees on the lower surface exerting air downward therefore creating more lift, the inflated keel being the center of gravity which allows the heili-kite to fly into the wind with accuracy at all times and has a stealth like shape (triangular) and does not require wind for lift, that is used in sports, recreation, work, play, fun, danger and warning zone, as a toy for children, teens, and adults alike, a location device for stranded individuals, and the unique shape and science of the said invention may be studied by plane builders, space craft builders and the like, even kite makers.

### BACKGROUND OF THE INVENTION

Kites or flying toys, for sport, recreational, and governmental purpose have taken many forms in relation to style, appearance, shapes, functionality, and types of materials used. Such kites or flying toys have been in the form of diamonds, triangles, box, 2 ply balloon kites filled with air or lighter than air gas such as helium, kites with keels, and kites without keels. There remains a need for an two-ply Mylar helium, air, or lighter than air substance filled keel kite, with an cambered streamlined airfoil inflated keel that runs the entire length of the kite from nose to tail that is designed to create an driving force and to reduce (induce drag) and heeling force, and to direct voracities energy into the cambered curved tail portion that in return is designed to catch voracities energy to produce extra lift in the tail section. The inflated keel also increases the angle of attack in the uni-body nose and leading edge of the wing section of the kite for greater lift in windy condition, and for a larger compartment to retain a mass amount of helium or lighter than air substance for greater lift in none windy condition, reinforced pleated wings for stability and structure of the stealth like shape (triangular) and the trailing edge of the wing shaped like that of the trailing edge of a bat's (rodent) wing, that any child or adult can operate easily, with one control line connected by means of tape or reinforced overlap with a hole or a series of holes for connection and adjustment of control line to the inflated keel, which is the center of gravity, for precision flight and control and can be operated outdoors and/or indoors.

### DESCRIPTION OF THE PRIOR ART

Kites or air and helium filled kites of various designs, styles, and materials of construction have been disclosed in the prior art. For Example, U.S. Pat. No. 4,919,365 to Allsopp discloses a combination of a kite and a helium balloon wherein the whole is lighter than the air so allowing the said combination to fly without wind, the kite hangs from the bottom of the balloon and is secured flush with the balloon by using adhesive tape, new balloons can be put on at any time by using the tape, the kite has a large keel for stability and a tail.

U.S. Pat. No. 6,499,695 B1 to Talamo discloses a balloon kite with a plurality of sized sheets of gas impervious sheet material that form one or more fillable interior chambers. The balloon kite is structured with extended and folded portions to secure a bridle and flying line to the balloon kite, with a coiled tail portion.

U.S. Pat. No. 4,919,365 to Mears discloses an air foil capable of being inflated either by using a lighter-than-air or other gas from a gas cylinder or by oral inflation comprising an aerodynamically shaped inflated portion, a flexible keel and two flexible winglets, one spaced on each side of the keel equipped with a tether system for stability and maneuverability in flight.

U.S. Pat. No. 5,762,293 to Crosbie discloses a two-piece inflatable kite is made from configured, mirror imaged top and bottom polyester films, which are heat sealed about their peripheral edge. Integrally extending from the edges forwardly and rearwardly are string connecting tabs formed from the top and bottom films. The tabs support reinforced apertures for attaching the kite string bridle. The top and bottom portions also form a valve for adding air into and out of an airtight compartment within the kite. The airtight compartment also forms the wings of the kite.

U.S. Pat. No. 3,957,228 to Kennedy Jr. discloses a thermodynamic kite with valves, regulators, and on board computer.

U.S. Pat. No. 4,026,504 to Christoffel Jr. discloses a maneuverable, deltoid-shaped, inflatable kite having when inflated, a bulbous nose portion, a central air beam, two diverging side air beams and an uninflated airfoil between the central air beams and each side air beam. Three control line anchors, a control bar, and maneuverability.

U.S. Pat. No. 4,216,929 to Holland Jr. discloses a keel kite having an increased range of flight speeds and an improved ability to withstand gusty winds, consisting of a mass-balanced sail portion eliminating the center line spar either entirely or over the rear central portion of the sail, and a separately mass-balanced keel portion supported by a spar along its lower edge.

U.S. Pat. No. 4,846,424 to Prouty discloses a ram airfoil stunt kite has upper forward edge provided with two stiffener members that provide a rounded leading edge and are connected together by a flexible joint. Two operator-held control strings are connected to bridles, which are, in turn connected to keels on the kite.

None of the prior art patents, however discloses a two-ply Mylar inflated keel kite having an when inflated cambered airfoil keel filled or inflated with air, helium, or lighter than air substance. Nor does any of the prior art disclose a two-ply Mylar kite having an air, helium, or lighter than air substance filled keel, wing, and tail airfoil uni-body design with reinforced pleated wings for structure and stability, a stealth like shape (triangle) uni-body wherein the trailing edge of wing is shaped like that of a bat's (rodent) wing, with an single guide line connected to the inflated keel by means of tape, or bonded to the inflated keel extended and folded portion by means of tying guide line through one reinforced hole, or a series of holes for adjustment of angle of attack for precision flight and control, that can be operated outdoors and/or indoors.

Accordingly, it is an object of the invention to provide an inflatable keel kite filled with air or lighter than air substance (helium), an airfoil kite having an airfoil inflated keel with an uni-body airfoil pleated wing, inflated keel, and inflated cambered tail portion, with an exciting eye catching novelty design that doesn't require wind to be blowing to rise in an upward direction and that will fly accurately in any substantial amount of wind always facing or flying toward the operator, and that is simple and easy to use for young children, teens, and adults alike.

Another object of the present invention is to provide a cambered streamlined airfoil inflated keel to help create more driving force and less healing force or induce drag.

Another object of the present invention is to provide a streamlined airfoil uni-body wing, nose, keel, and tail design for precision flight and stability.

Another object of the present invention is to provide an easy to use flying toy that is used for outdoor and/or indoor fun, sports, ornamentive, decorative, and the like, for people with limited kite flying knowledge and/or limited mobility such as young children or elderly people that is easy to operate with easy one hand operation.

Another object of the present invention is to provide a flying device that can be operated in doors with ease for situations such as, rainy days or bad weather, banquets or balls, birthday and party events, elderly and/or people that have limited mobility that can't leave the house to even try to fly a kite, or even a get well present for ill people.

Another object of the present invention is to provide an accurate and persist flying device that doesn't require any wind to assume lift or to rise upward in a rapid manor for emergency location deploying device, a warning device, a signal for help device, a displaying device, for advertisement, marker, and the like.

Another object of the present invention is to provide a heili-kite that can be sold inflated with air or lighter than air substance preferably helium, or sold in a fin or party kit, or an emergency kit, ects, with all the essentials needed to deploy and fly kite, such as helium and/or air, tape or bonding substance, string or string substance, and for added pleasure some stickers and/or coloring devices to dress up the said invention and the like.

Another object of the present invention is to provide a low cost product that can be mass-produced, with all the materials needed for fabrication already existing.

Another object of the present invention is two provide a heili-kite that can be operated with a single control line or with a duel control line for steering control of the invention.

Another object of the present invention is to provide a kite that can be remote controlled with added means of propulsion.

### SUMMARY OF INVENTION

In accordance with the present invention, the heili-kite is fabricated by means of two-ply Mylar materials, to form an airtight fillable and refillable pocket, when this uni-body pocket is inflated it forms a series of airfoil surfaces such as the inflated keel, the nose portion, the wing section, and the tail. The fillable pocket includes one or more fallible pleats that are all fillable through a single filling valve, port, ects, the uni-body design when filled or inflated requires no additional support means. The helium inflated keel kite of the inventions purpose is to enable a small child or an elderly person that may not be able to fly a kite due to limited mobility or kite flying skills to enjoy the pleasures of kite flying and wonders, indoors and outdoors, wind or none, the heili-kite will fly at low altitudes for indoors and at high altitudes for outdoors. The inflated keel of the said invention allows for a larger capacity of helium, therefore creating extra lift for a fast take off and higher altitudes, there is an altitude ceiling that is present in none windy conditions as the weight of the control line becomes as heavy as the said invention the two forces balance out to create a ceiling limit of altitude, so the lighter the control line is, the higher the altitude ceiling limit becomes, when there is wind blowing the said invention will rise to great altitudes and flying accuracy.

It is believed that the enjoyment, entertainment, and amusement experienced while operating the said heili-kite may be increased, with the disposing of various designs such as team names, animal and cartoon caricatures, corporate logos, movie/TV personalities, printed indicia, borders or flower patterns, abstract designs, advertisement, business and marketing slogans, trade marks and the like.

The heili-kite in accordance with the invention is fabricated from one or more layers of Mylar materials, individual layers may be brought together to form the two-ply air tight pocket and shape of the invention, or one single layer may be over lapped and creased to form the two-ply air tight pocket, the control line may be attached by means of bonding the line to the inflated keel with tape, glue, and the like, or by attaching the control line to an reinforced, extended, and creased series of holes on the inflated keel at the center of gravity.

The heili-kite in accordance with the invention is a two-ply Mylar materials brought together and/or overlapped and bonded together by means of heat sealed seams in combination with reinforced bonded pleats, the edges or seams can be bonded together by means of heat sealing, gluing, taping, and the like, the said pleats may be reinforced by means of heat sealing, gluing, tape and the like. The tail portion of the said invention is inflated for extra lift in none wind conditions, and is cambered and curved downward to catch voracities energy in wind conditions.

### DESCRIPTION OF THE DRAWINGS

Further objects, features, and advantages of the present invention will become apparent upon consideration of the detailed description of the presently preferred embodiments, when taken in conjunction with the accompanying drawings, wherein:

FIG. 1 is a lower frontal perspective view of the present invention of the Heili-kite being in an aloft position showing the inflated keel running along the bottom of kite form nose to tail, it shows the bonded seams, it also shows the inflated nose section conjoined to the pleated inflated wing, and to the inflated keel to form a uni-body design and it also shows the pointy flap like trailing edge and optional tail piece.

FIG. 2 is a rear perspective view of the Heili-kite showing the inflated keel, inflated tail, and pleated wing in an airfoil uni-body design, it shows the bonded seams, the airfoil down step from the top of nose to top of wing, and pointy flap like trailing edge of wing, it also shows the width and depth of the rear section of the inflated keel, (note the width and depth of the inflated keel in the rear view of FIG. 2 relevant to the width and depth of the inflated keel in the front view of FIG. 9. The front view of the keel in FIG. 9 is wider and deeper than the rear view of the keel, the widened front section of the keel allows for a strong structure of the uni-body nose and wing, and for a wider angel of attack on the wind stream for maximum lift, and the narrower rear section of the keel offers a stream line effect for precision performance.

FIG. 3 is a top perspective view of the Heili-kite showing the uni-body inflated nose, pleated wing, with the trailing edge of wing shaped like that of a bat's (rodent) wing it also shows the pointy trailing edge for a flap like feature, inflated tail with inflation valve, optional tail piece, bonded edge seams and the triangular outline shape of the said invention that is not numbered.

FIG. 4 is a side perspective view of the Heili-kite in an aloft and flying position with an illustration of the wind blowing, it shows the wind crossing over the top of the airfoil cambered nose section and under and around the airfoil inflated keel running along the bottom of the kite from the nose to the cambered, downward curved, airfoil inflated tail, it also shows the wind voracities energy being absorbed by the airfoil cambered inflated tail, and it shows the angled back stealth like shape of the wing (not numbered), and its cambered airfoil shape, and it shows the scotch tape that bonds the control line to the inflated keel and the series of holes in the bonded seam of the inflated keel, note the angel of the kite relevant to the control line.

FIG. 5 is a side perspective view of the Heili-kite being in an aloft position with no wind blowing or present, note the angel of the kite relevant to the control line, it shows the scotch tape that bonds the control line to the inflated keel, it also shows the uni-body inflated nose, wing, keel, tail section and pointy flaps on trailing edge of wing.

FIG. 6 is a cutaway top view of the Heili-kite to show the reinforced seams of the pleated wing reinforced with two-face tape (glass tack) for seams, and scotch tape for reinforcement of the nose end of the seamed pleats to prevent leakage due to splitting, or separation of the seams, it also shows the pointy ends of the wing for a flap like feature and the trailing edge of the wing shaped like that of a bats (rodent) wing.

FIG. 7 is a cutaway close up of the reinforced seams showing the scotch tape positioned at the nose end of the seam on the inside of the kite, it also shows the two-face tape that bond the pleats and it shows how the cambers of the pleated wing is formed.

FIG. 8 is a cutaway side view of the reinforced pleat showing the scotch tape at the nose end of the seam or pleat, it also shows the two-face tape with the top layer and the bottom layer of the Mylar materials that form the pleat.

FIG. 9 is a front perspective view of the inflated keel kite showing the top Mylar surface of the kite and the two bottom Mylar surfaces bonded at the edges and down the middle of the inflated keel to form an airtight pocket, it also shows the width and depth of the front or nose section of the heili-kite.

FIG. 10 is a front/side view of the second embodiment of the Heili-kite inflated keel kite showing the trailing edge of the wing to have a strait oblong pleated shape.

### DETAILED DESCRIPTION OF THE PREFERED EMBODIMENTS

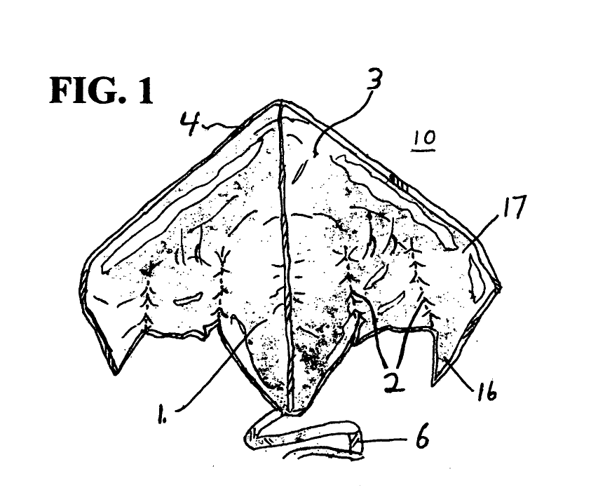

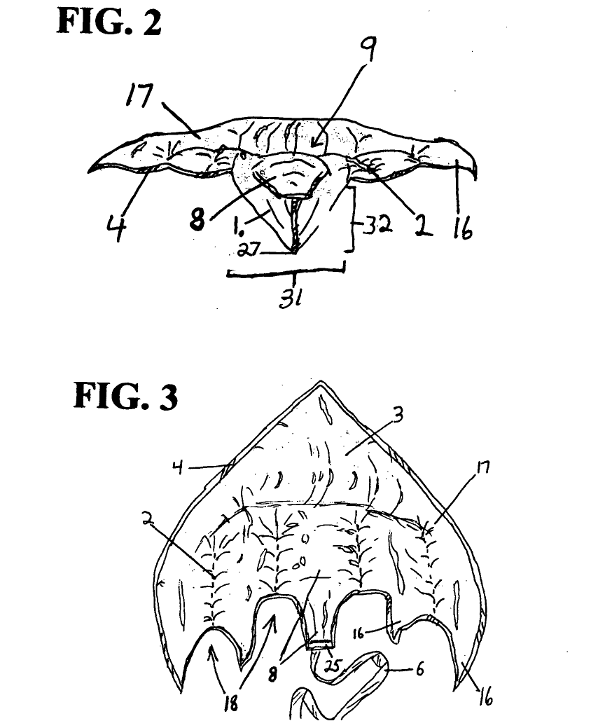

Referring to FIG. 1 thru 10 the heili-kite 10 may generally be seen. FIG. 1 shows the kite 10 has an inflated keel 1 which is uni-bodied with the inflated nose 3, the inflated wing 17, and the inflated tail 8 shown in FIG. 2 thru 5. FIG. 1 shows the pleats 2 that form the uni-body shape, the edges of the kite are sealed at the bonded seams 4, and the wing 17 of the kite 10 has pointy flaps 16 on its trailing edge, the kite 10 also has an optional tailpiece 6.

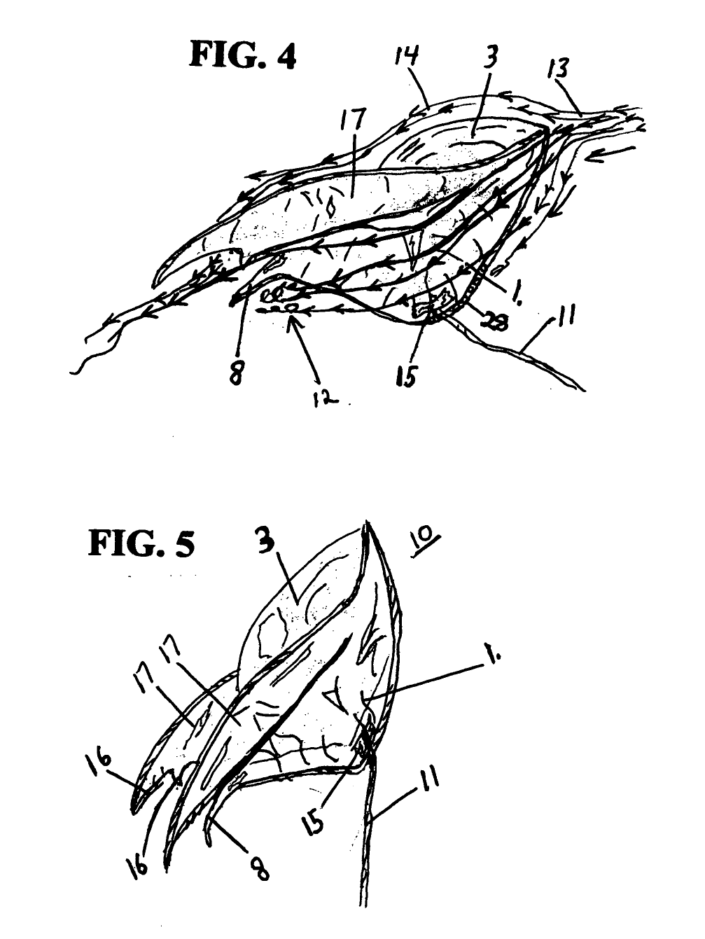

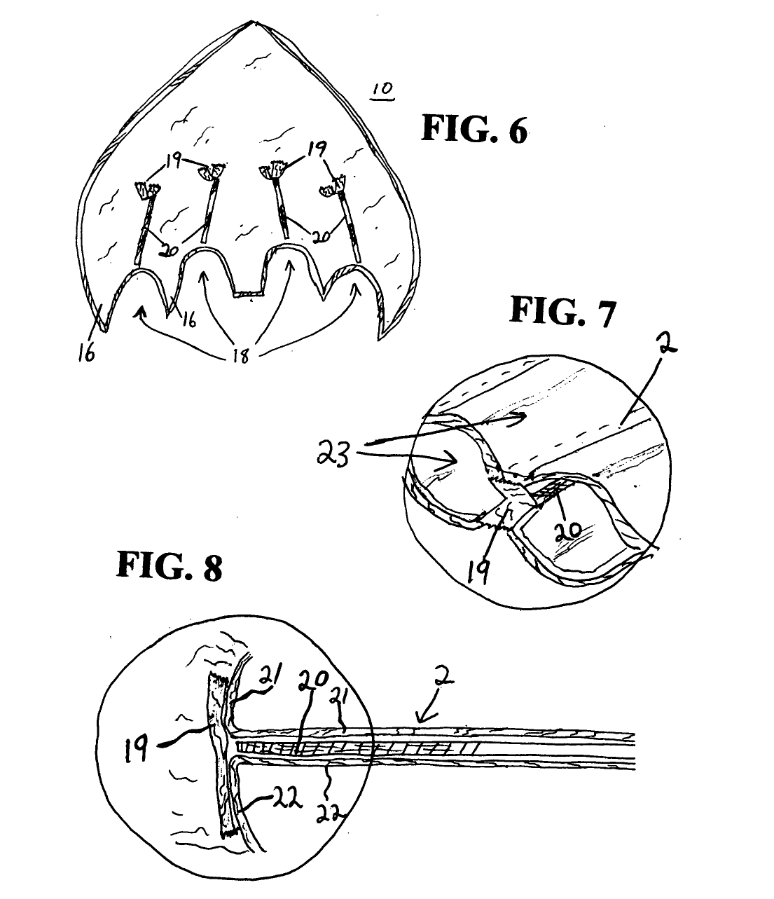

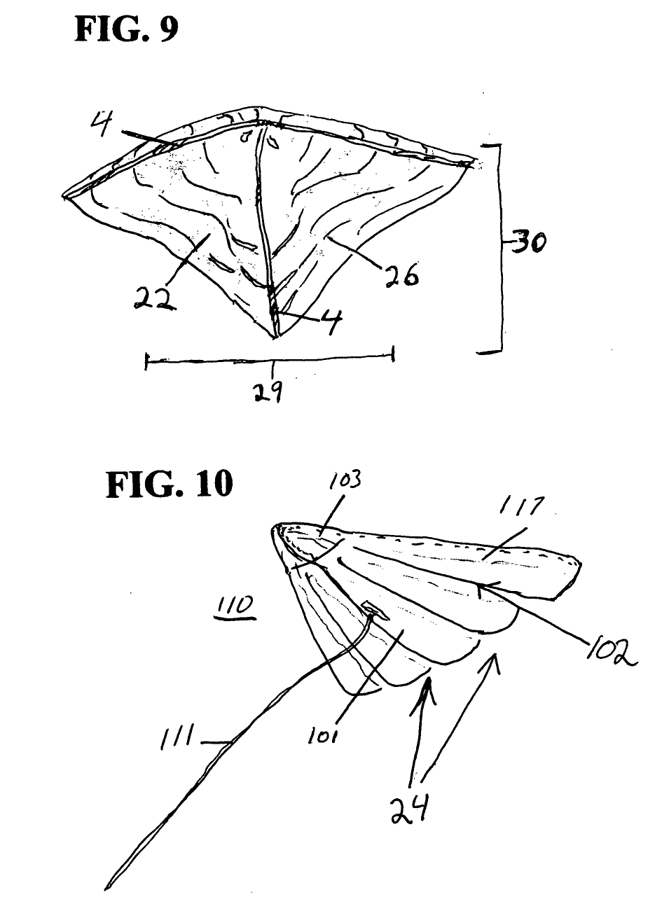

Referring to FIG. 2 is a rear view showing the heili-kite 10 and its component sections, there is an down step 9 from the top surface of nose 3 to the top surface of wing 17 that form an airfoil structure, the inflated tail 8 is cambered and curved downward to absorb voracities energy 12 that is created by the inflated keel 1 and wing, the wing 17 has pleated seams 2 and pointy flaps 16 at its trailing edge, FIG. 2 also shows the inflated keel 1 and the heat bonded seams 4 that are at the kites 10 edges and down the center of the said keel 1 to form an wind splitting edge 27, and it also shows the width 31 and the depth 32 of the rear section of the inflated keel. The top view of FIG. 3 shows the bonded seams 4, and the shape of the trailing edge of wing 18 shaped like that of the trailing edge of a bats wings trailing edge, it also shows the inflated nose portion 3, the pleated 2 inflated wing 17 which is the structure of the kite 10, and the inflated tail section 8 as a uni-body design, there are pointy flap like flaps 16 at the wings trailing edge 18, and a fill/refill valve 25 at the end of the inflated tail section 8 with an optional tailpiece 6 as shown and described. FIG. 4 is an illustration of the heili-kite 10 in flying action with the wind stream 13 moving in the direction from the nose 3 to the tail 8; note the position of the control line 11 relevant to the kite. As the wind or air 14 crosses over the nose 3 and wing 17 uni-body, the airfoil aerodynamically designed shape of the top surface of kite 10 creates lift in windy conditions and or artificial wind such as running. And The streamline shape of the uni-body wing 17 reduces form drag, the wind 13 crossing under the wing 17 is being split in two directions, to the left and right side of the inflated keel 1, the airfoil camber shape of the inflated keel 1 causes the air/wind to treat both sides of the keel as if it were the top of an airplane (airfoil) wing, with a streamline trailing edge at the rear of keel 1 that creates and directs (vertical voracities) energy 12, into the inflated curved down tail section 8 to produce extra lift in the tail section 8, and extra driving force in kite 10. It also shows the control line 11 taped 15 to the inflated keel 1, and it shows a series of holes 28 on the bonded seam 4 of the inflated keel 1 for optional connection of the control line for adjustment of angel of attack. As shown in figure FIG. 9 The width 29 and depth 30 of the inflated keel 1 also increases the angel of attack on the air stream there fore creating extra lift like a boat on water, wherein combined with the airfoil top surface of kite 10 offers the user a high performance fast lifting kite 10 as shown and described. FIG. 5 shows the kite 10 in an aloft position with no wind stream or movement, note the position of the control line 11 relevant to the kite 10, the control line 11 is bonded to inflated keel 1 by means of tape 15, there are pointy flaps 16 at the trailing edge of the wing 17 and a cambered curved downward tail 8. FIG. 6 shows a top cutaway view of the kite 10 to show the formation and structure of the pleated uni-body wing 17, there is two-face (glass tack) tape 20 that bonds the top layer of kite to the bottom layer of kite to form the reinforced pleated seams 2 as shown below in FIG. 7, FIG. 6 also shows the reinforcement of the ends of the seams with scotch clear tape 19 to prevent splitting or separation of the seams at the nose end of pleats 2, the tape 19 attaches the top layer of the kite to the bottom layer across the seam or pleats 2 for reinforcement, a front side angle cutaway view in FIG. 7 shows the tape 19 crossing the seam or pleat 2, it shows the two-face tape 20, and the formed chambers 23. FIG. 8 is a perspective cutaway side view of FIG. 7 again showing the fabrication of the reinforced pleats 2, the two face tape 20 forms the pleats 2 bonding the top layer 21 to the bottom layer 22, the tape 19 crosses the seam or pleat 2 for reinforcement to prevent splitting or separation of the seam or pleat 2. Referring to back to FIG. 6 the trailing edge 18 of the wing 17 is shaped like that of a bats (rodents) wings trailing edge and has pointy flaps 16 that aid in the performance of the invention 10. FIG. 10 is a second embodiment of the heili-kite 110 having an inflated keel 101, inflated nose 103, the control line 111 and uni-body wing 117. The wings are pleated 102 and the trailing edge of the wing 24 is slightly curved across from left to right. The trailing edge of the second embodiment can also be strait across with no curve from left to right and the pleats in the wing can run from left to right also.

What is claimed is:

1. The heili-kite, having a cambered streamlined airfoil inflated keel, filled with helium, air, or lighter than air gas, with a streamlined cambered airfoil inflated keel, nose, wing and tail uni-body, a cambered curved downward tail, a triangular stealth like shape, reinforced pleated wing, with the trailing edge of wing shaped like the trailing edge of a bats wing comprising:
a) A cambered airfoil inflated keel.
b) Reinforced pleated wing, that form the fillable chambers in the wing, the pleats also form the stealth like shape of the kite and tail, the pleats are the skeletal structure of the heili-kite that distinguish the certain sections of the invention like the nose, wing, tail, and the inflated keel.
c) A uni-body inflated keel, nose, tail and pleated wing.
d) A cambered curved down ward airfoil inflated tail.
e) One fill/refill valve on the tail section that fills all chambers of the invention with air or a lighter than air substance like helium.
f) An aerodynamic heili-inflated keel kite.
g) Reinforced pleats with means of bonding the top Mylar layer of the kite to the bottom Mylar layer of the kite with two-face tape, glue, heat, or the like.
h) Reinforced pleat ends with one sticky side tape across the seam to prevent splitting, ripping, or tearing of the pleats for durability.
i) A single control line connected to the inflated keel by means of tape, glue, and the like, or by connecting to a series of reinforced holes in the seam of the keel at the center of gravity for adjustment of angel of attack.
j) The trailing edge of the wing shaped like the trailing edge of a bats (rodent) wing, with pointy flap like flaps.
k) A wide and deep inflated keel for a greater center of gravity, and steeper angel of attack on the wind stream while the wind is blowing,

2. The heili-kite in accordance with claim 1, wherein a top Mylar layer of the kite is bonded to the bottom Mylar layer or layers of the kite to form a series of fillable chambers.

3. The heili-kite in accordance with claim 1, wherein there are means of reinforcements of the pleats of the invention.

4. The heili-kite in accordance with claim 1, wherein the invention can be completely filled with a lighter than air substance such as helium for flight when there is no wind allowing a small child or an elderly adult with limited kite flying knowledge and or mobility to have the sensation of flying a kite indoors.

5. The heili-kite in accordance with claim 1, wherein the inflated keel holds an extra mass of helium in a compact kite for a fast take off and high flying altitude.

6. The heili-kite in accordance with claim 1, wherein the Mylar material to build the kite can be substituted with other kite making materials that can be bonded together to form an airtight pocket.

7. The heili-kite in accordance with claim 1, wherein the invention can be used for sports, pleasure, science, warning zone, deployed for a help signal for lost or stranded people, as a toy or novelty for children, teens and adults alike.

8. The heili-kite in accordance with claim 1, wherein the user can enjoy the sensation of flying a kite indoors because they may not be able to leave the house or confinement.

9. The heili-kite in accordance with claim 1, wherein the inflated keel creates vertical swirls of air at its trailing edge while the wind is blowing, theses vertical swirls are called vertical voracities, which are directed into the cambered curved downward inflated tail to produce extra lift in the tail section.

10. The heili-kite in accordance with claim 1, wherein the top surface of the kite has a down step from the nose section down to the top of the wing creating an airfoil aerodynamic shape of the combined nose, wing uni-body.

11. The heili-kite in accordance with claim 1, wherein the airfoil-inflated keel is designed to creates an extra driving force.

12. The heili-kite in accordance with claim 1, wherein the heili inflated keel kite is aerodynamically clean.

13. The heili-kite in accordance with claim 1, wherein the invention has a fill/refill valve at the trailing edge of the tail section, in which the filling of the kite can occur thru a single valve.

14. The heili-kite in accordance with claim 1, wherein the said invention can have an optional tailpiece.

15. The heili-kite in accordance with claim 1, wherein the trailing edge of the wing section has pointy flap like flaps and is shaped like the trailing edge of a bats (rodent) wing.

16. The heili-kite in accordance with claim 1, wherein there is a bonded seam running along the center of the inflated keel, and about the sealed edges of the invention.

17. The heili-kite in accordance with claim 1, wherein the invention can be decorated and sold with stickers and colors markers or paint for decorating with your own touch, and/or with team names, logos, printed indicia, cartoon and animal caricatures, advertisement, movie/TV, school names, different colors, personalities and the like.

18. The heili-kite in accordance with claim 1, wherein the said invention can be fabricated of other materials that is lightweight and can offer a sealed airtight pocket.

19. The heili-kite in accordance with claim 1, wherein the invention can be sold already inflated with helium gas, air or lighter than air substance.

20. The heili-kite in accordance with claim 1, wherein the said invention can be sold as a field kit, an emergency kit or a party package with all the needed accessories like the control line, extra tape for patching and connecting the control line to the inflated keel, a tank of helium, and extra heili-kites.

21. The measurements of the preferred embodiments of the present invention when inflated are from nose of said kite to tip of wing measures 32 inches in wing length, the overall length of said kite from nose to tail is 26 inches, with a 32 inch wing span. On the bottom surface of the kite toward the nose section is The widest portion of the keel which is the point of integration of the uni-body keel, wing, and nose is 15 inches in width and a rear bottom width measurement of the keel at the tail section is 9 inches and slims out into a streamlined trailing edge, with a keel depth measurement from top surface of kite to lowest portion of keel of 12 inches, the length of the pleats that are in the wing and form the shape of the heili-kite, range in measurements from 1 inch, to tip of the nose of the said kite, and the width can range from a narrow hair line to 24 inches. The length of the pleats that are in the wing and that form the shape of the preferred embodiment shown in FIGS. 1 thru 6 of the said invention are measurements of 7 inches in length and ¼ inch in width.

22. The heili-kite in accordance with claim 1, wherein the measurements of the preferred embodiments of the present invention when deflated are from nose of kite to tips of wing is 36 inches in wing length, the over all length of the said invention is 30 inches in length from nose to tail section, with a wing span measurement of 36 inches and a keel depth of 6 inches in measurement.

23. The third embodiment of the present invention shown in FIG. 9, wherein the form of the preferred embodiment shown in FIGS. 1 thru 6 of the inflated keel kite has no pleats.

24. The heili-kite in accordance with claim 1, wherein the pleats are on the hump portion of the trailing edge.

25. The heili-keel kite in accordance with claim 1, wherein the pleats are in the valley of the pointy flap like flaps at the trailing edge of the wing.

26. The heili-kite in accordance with claim 1, wherein the kite can be operated by means of duel control line for controlled steering of the invention.

27. The heili-kite in accordance with claim 1, wherein the invention can glow in the dark.

28. The heili-kite in accordance with claim 1, wherein the invention can have motors added to it to be controlled by remote.

29. The heili-kite in accordance with claim 1, wherein the invention can have one or more control lines.

30. The heili-kite in accordance with claim 1, wherein the invention can have one or more inflated keel and/or keels.

31. The heili-kite in accordance with claim 1. wherein the invention can have one or more bridle or bridles connecting the control line and or lines to the inflated keel and or keels and to the body and/or to both the body and the keel and/or keels.

32. The heili-kite in accordance with claim 1. wherein the invention has no inflated keel or keels and instead has one or more bridles connecting the control line and/or lines directly to the body.
